(19) United States
(12) Patent Application Publication
(10) Pub. No.: US 2011/0310004 A1
(43) Pub. Date: Dec. 22, 2011

(54) APPARATUS AND METHOD FOR SETTING A PARAMETER VALUE

(75) Inventor: Martin Trasler, Stevenage (GB)

(73) Assignee: AEROFLEX INTERNATIONAL LIMITED, STEVENAGE (GB)

(21) Appl. No.: 13/131,834

(22) PCT Filed: Nov. 11, 2009
(86) PCT No.: PCT/GB09/51511

§ 371 Date: Sep. 12, 2011

(30) Foreign Application Priority Data
Nov. 11, 2008 (GB) 0820585.8

(51) Int. Cl. G09G 5/00

(52) U.S. Cl. 345/156

(57) ABSTRACT

Embodiments of the present invention relate to an improved man-machine interface for an apparatus. The interface comprises at least one graphical representation of a controllable parameter.

### FIELD OF THE INVENTION

Embodiments of the invention relate to an apparatus and method of control thereof.

### BACKGROUND TO THE INVENTION

Referring to FIG. 1, there is shown an embodiment of a front panel 100 of digital RF signal generator. The front panel 100 corresponds to that of a 3410 Series Digital RF Signal Generator available from Aeroflex International Limited. The 3410 Series Digital RF Signal Generator manual, document part no. 46892/499, which is incorporated herein by reference, is also available from Aeroflex International Limited.

The front panel 100 comprises a standby/on switch 101, an RF output 102 in the form of a 50Ω N-type socket, an external Q input or external frequency modulation input 103 and an I input or external amplitude modulation input 104. The front panel 100 also comprises a touch-sensitive display 106 and a keyboard 108.

FIG. 2 shows an expanded view 200 of the keyboard 108. It can be appreciated that the keyboard 108 comprises navigation keys 202, function keys 204, a numeric keypad 206, terminator keys 208, output control and diagnostic keys 210 and increment/decrement keys and a rotary control 212. The function and operation of each of the above are described in detail in the above referenced document.

A function is initially selected using the touch-sensitive display 106 either on a function label or by selecting a parameter value of interest. It is possible to select functions using their corresponding keys on the keyboard 108, the numeric keypad 206 or the rotary control 215.

The numeric keys are used to set parameters to specific values, which can be varied in steps of any size using the “×10” 214 and “÷10” 216 keys and/or the rotary control 215. The “×10” 214 and “÷10” 216 keys are used to adjust the rotary control sensitivity or resolution.

A development of the man-machine interface of digital RF signal generators sought to simplify its physical characteristics. The simplification provided a larger touch-sensitive screen and displayed keyboards, rotary controls and the like on the touch-sensitive screen instead of providing physical keys and rotatable knobs.

For example, the 6413A UMTS (3G) Base Station Test System also available from Aeroflex International Limited comprises a front panel 300 that has a large touch-sensitive screen 302 as can be appreciated from FIG. 3. The touch-sensitive screen 302 is used to provide an intuitive man-machine interface such that all functions of the test system can be accessed and controlled. Of particular interest is the graphical rotary control 304, which is operable in a manner that is substantially identical to the rotary control 215 described with reference to FIGS. 1 and 2.

However, it has been found that it can be difficult to enter certain categories of parameters using rotary controls, in particular using software realised rotary controls.

In particular, without a physical rotary control present, it is difficult to move one's finger in a circle using a touch screen as there is no physical wheel to guide your finger. Furthermore, it is very difficult to move one's finger quickly to modify a value by large amounts quickly for the same reason. Still further, there is very little feedback regarding how much a finger needs to be moved to effect a desired modification to the parameter or value of interest.

It is an object of embodiments of the invention to at least mitigate one or more problems of the prior art.

### SUMMARY OF EMBODIMENTS OF THE INVENTION

Accordingly, embodiments of the invention provide an apparatus as claimed in claim 1.

Advantageously, embodiments of the invention support making adjustments to numerical values. Particular embodiments support making such adjustments to such numerical values having a certain category of dynamic range such as, for example, a large dynamic range. Still further, such adjustments can be realised preferably without requiring a user to enter the entire numerical value using a numeric keypad.

Embodiments of the present invention advantageously allow a finger, stylus or other integer to move in a substantially straight line, which means that it is much easier to control the apparatus, that is, to vary the parameter. Furthermore, while there is an absence of feedback in the case of a rotary control, the indicia on one or more of the sliders provide an indication of the current value of the numerical value or parameter, which, in turn, allows one to appreciate by how much the parameter has changed or has to change before a target or desired value is reached.

### BRIEF DESCRIPTION OF THE DRAWINGS

Embodiments of the present invention will now be described, by way of example only, with reference to the accompanying drawings in which:

FIG. 1 shows a first prior art signal generator;

FIG. 2 depicts a more detailed view of the prior art signal generator of FIG. 1;

FIG. 3 illustrates a prior art test system;

FIG. 4 shows an apparatus according to an embodiment;

FIGS. 5 to 13 depict various pairs of sliders according to respective embodiments;

FIG. 14 illustrates a flowchart showing processing steps according to an embodiment of the invention;

FIG. 15 shows a screen-display according to an embodiment; and

FIG. 16 shows a screen-display according to an embodiment.

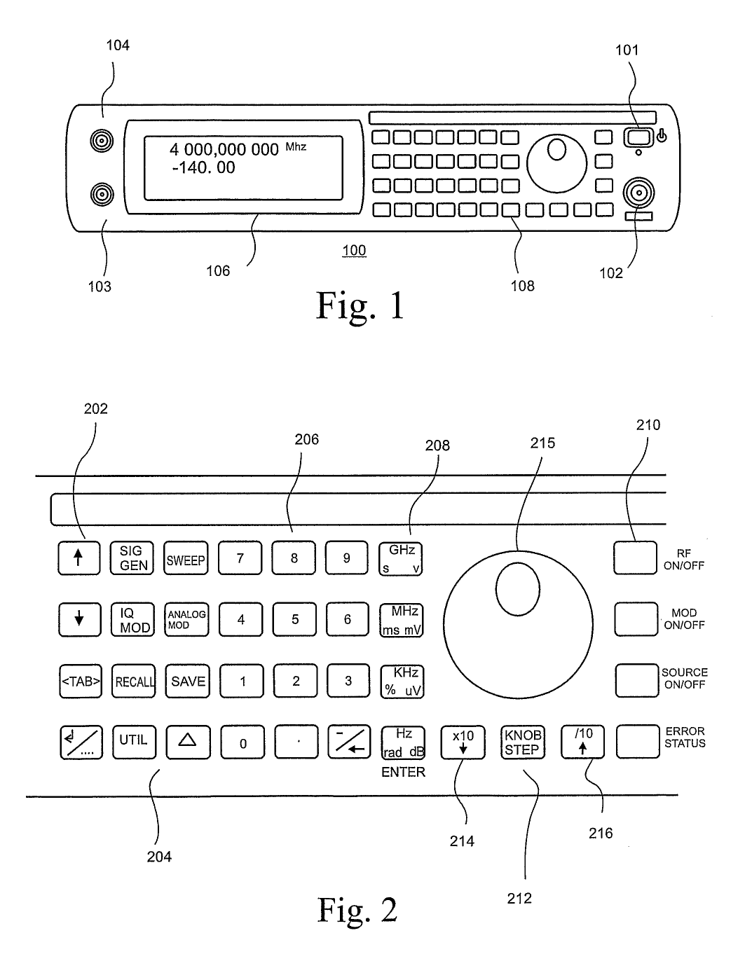

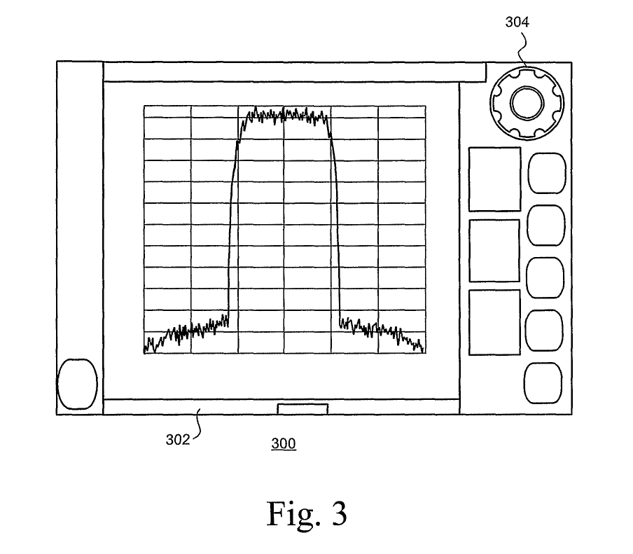

### DETAILED DESCRIPTION OF EMBODIMENTS

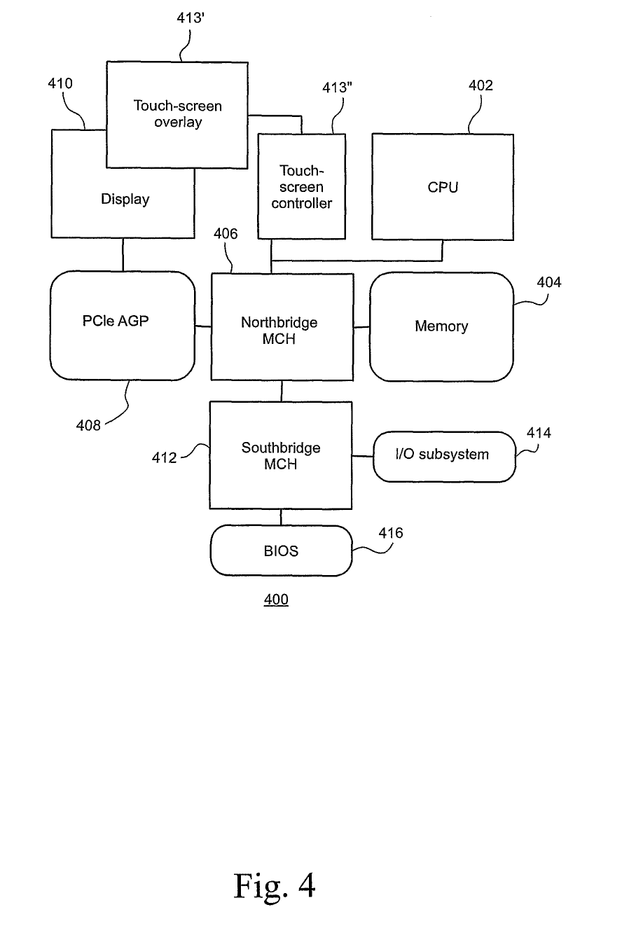

FIG. 4 shows a schematic representation of an apparatus 400 according to an embodiment of the invention, which is preferably realised as an embedded PC. The apparatus comprises a CPU 402 for executing software used in realising the embodiment of the invention. The software is stored in memory, such as, for example, ROM/RAM, 404 as is well understood within the art of embedded PCs for execution by the CPU 402. The CPU 402 is connected to a memory controller hub (MCH) 406 that manages the interactions with the other chips forming the apparatus. The MCH 406 is coupled to the memory 404 and to a graphics controller 408. The graphics controller 408 controls the operation of the screen 410. In the present embodiment the screen is a touch-sensitive screen. The MCH 406 is coupled to a south-bridge or I/O controller hub (ICH) 412. One skilled in the art appreciates that embodiments realised using a touch-sensitive display comprise a touch-sensitive membrane or overlay 413′ coupled with a touch-screen controller and driver 413″. The touch-screen controller and driver converts presses into events that the system can use. The ICH 412 is connected to various I/O subsystems 414 and to a BIOS 416. The detailed structure, chipset and operation of the above will not be described because they are familiar to one skilled in the art.

Images or graphical outputs/representations (not shown) depicted on the display 410 are generated by the graphics controller such as, for example, an AGP Intel 740 or some other display controller resident in the AGP.

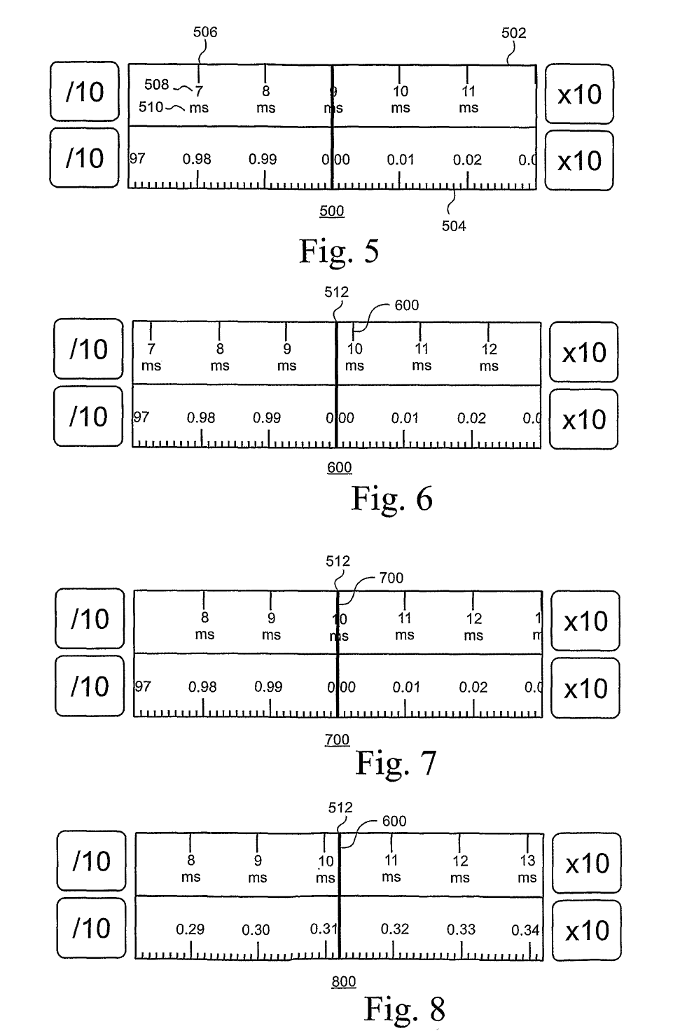

The software is arranged to present a pair of sliders 500, which, as can be seen in FIG. 5, are graphically represented on the touch-sensitive display 410. The pair of sliders 500 comprises a first slider 502 and a second slider 504. The first slider 502 is used to represent a first portion of a numerical value or parameter to be controlled or varied in response to user input such as, for example, an integer portion. The second slider 504 is used to represent a second portion of the numerical value or parameter to be controlled or varied in response to user input such as, for example, a fractional or decimal portion. In preferred embodiments, the numerical value will be stored in memory or some other form of storage such as a register. Preferably, the numerical value or parameter is used to influence the generation or analysis of a physical signal such as for example a signal having a particular characteristic that is governed by the numerical value. The particular characteristic can be one or more of frequency, voltage amplitude, current amplitude, modulation type, modulation index, time such as Capture time or Capture length, measurement span, sample rate, graphical marker position in frequency or time. One skilled in the art appreciates that the embodiments of the invention can be used to control any numerical value. The I/O subsystem is used to produce physical manifestations of signals according to the numerical value or parameter. Embodiments of the invention can be used to modify the value in terms of integer and decimal parts, real and imaginary parts, I and Q parts of a signal, exponent and mantissa parts. Furthermore, in terms of coordinates, the slider could be used to set or modify one or more coordinates, preferably simultaneously.

It can be appreciated that the first slider 502 comprises a number of ticks such as, for example, the first tick 506 from the left. The ticks have associated values and units. The units can represent units of measurement or units of control. For example, the first tick 506 has an associated value of “7” 508 and an associated unit of milliseconds 510. The same applies to the other ticks shown on the first slider 502. It can be appreciated that the first slider 502 depicts a portion of a current dynamic range of the numerical value or parameter to be controlled starting with a displayed lower bound and finishing with a displayed upper bound. The slider depicts a small portion of the overall dynamic range of the numerical value or parameter. It will be appreciated, however, that the bounds of the slider are not the same as the upper and lower bounds of the parameter in general. However, one skilled in the art will appreciate that the displayed upper and lower bounds are merely illustrative and do not represent the full dynamic range over which the numerical value or parameter can be controlled or varied.

Similarly, the second slider 504 comprises a number of ticks or graduations representing the decimal or fractional part of the numerical value or parameter being controlled, varied or set.

In the illustrated embodiment, the slider depicts a numerical value of exactly 9 ms as can be appreciated from the central indicator bar 512.

In the case of a touch-sensitive display, if a finger or stylus is moved left or right on an area of the overlay 413′ corresponding to one of the sliders 502 or 504, the graphical depiction of the numerical value moves correspondingly. Therefore, for example, moving the first slider 502 left will increase the numerical value or parameter. Moving the first slider 502 right will reduce the numerical value or parameter.

Releasing a currently actuated slider, that is, lifting the finger or stylus, will cause the tick of the slider that is nearest to the indicator bar 512 to snap to that indicator bar thereby aligning the tick with the indicator bar 512.

Embodiments can be realised in which the slider movement progressively slows down following release before snapping into alignment with the indicator bar.

It will be appreciated that the numerical values represented by the ticks of the second slider 504 are arranged to wrap around and span upper and lower bounds, that is, have a dynamic range, dictated by the units of the first slider 502. In general, moving the slider 504 left will increase the numerical value or parameter and moving the slider 502 right will decrease the numerical value or parameter.

FIGS. 6 to 8 illustrate how to set the numerical value or parameter to 10.312 ms given a current value of 9 ms. Referring to FIG. 6, it can be appreciated that the first slider 502 has been moved left such that the tick 600 associated with 10 ms value is nearest the indicator bar 512 when the slider is released or no longer being actuated by the user. FIG. 7 shows the tick 600 associated with the 10 ms value having snapped to the indicator bar 512. FIG. 8 shows the second slider 504 as having been moved such that the tick associated with 0.312 ms has snapped into alignment with the indicator bar 512. Therefore, the numerical value or parameter will take on the value 10.312 ms.

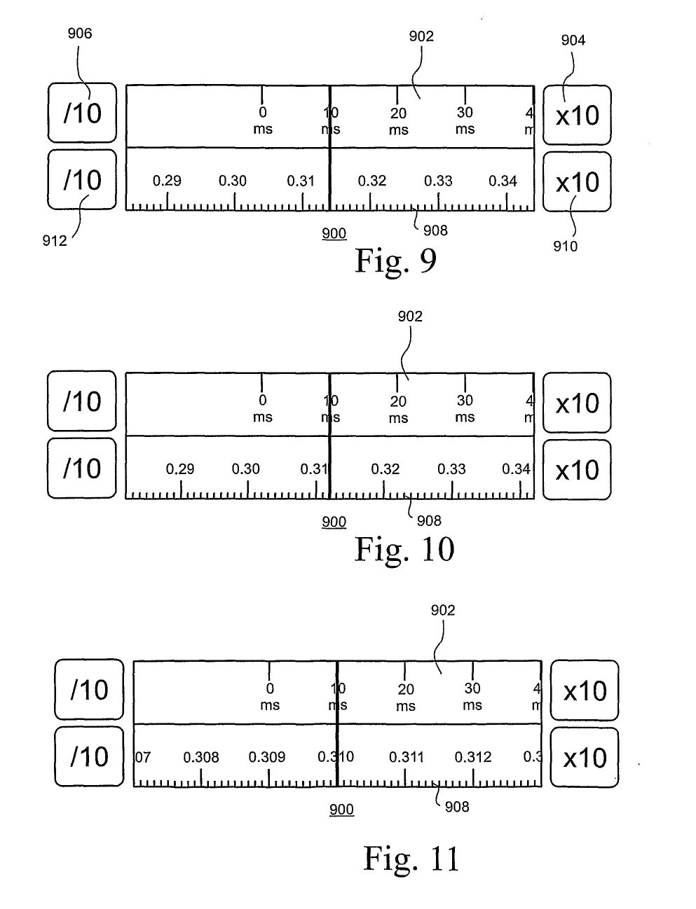

A further embodiment of the invention can be realised in which increment and decrement functions are associated with one or more of the sliders. Referring to FIG. 9, there is shown a pair of sliders 900. A first slider 902 of the pair 900 has associated first 904 and second 906 buttons. The first button 902 has an associated increment function. The second button 906 has an associated decrement function. The second slider 908 also has an associated pair of increment and decrement buttons/functions 910 and 912. One skilled in the art will appreciate that the increment and decrement buttons are embodiments of actuable devices.

The increment and decrement buttons and associated functions serve the purpose of allowing the units to be changed. In a preferred embodiment, the increment and decrement buttons vary the scale of their associated sliders. For example, the increment button 904 will increase the scale of the first slider 902 by a predetermined amount or in a predetermined manner. Embodiments can be realised in which the increase in scale corresponds to a factor of 10 increase. However, embodiments are not limited to such a multiplicative factor or, indeed, to multiplicative increases. Embodiment can be realised in which some other factor or increase in scale is used. Similarly, the decrement button 906 will decrease the scale of the first slider 902 by a predetermined amount or in a predetermined manner. Embodiments can be realised in which the decrease in scale corresponds to a factor of 10 decrease. However, embodiments are not limited to such a multiplicative factor. Embodiments can be realised in which some other factor or decrease in scale is used. FIG. 10 illustrates the pair 900 of sliders in which the scale of the first slider 902 has been increased by a factor of 10. FIG. 11 depicts the pair of sliders 900 with the second slider 908 having had its scale decreased by a factor of 10 from 0.01 resolution to 0.001 resolution.

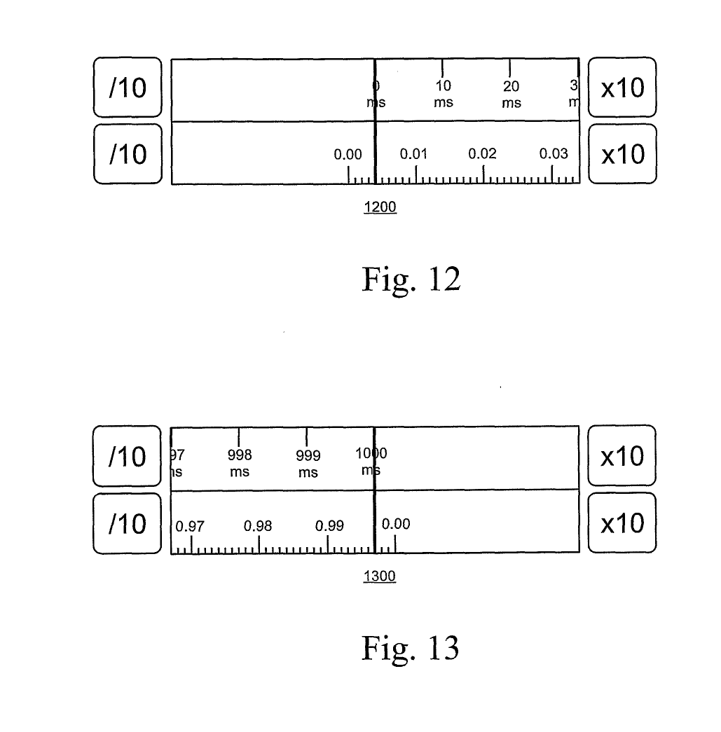

It will be appreciated that the dynamic ranges of the sliders might be varying according to intended capabilities of the apparatus such as, for example, maximum signal amplitude, current etc. Therefore, embodiments can be realised in which the ticks shown on the sliders are only depicted for values that fall within the dynamic range of the numerical value, parameter or signal characteristic being controlled. FIGS. 12 and 13 shows respective sliders 1200 and 1300 depicting an absence of ticks beyond the upper and lower bounds of the parameter being controlled or varied on reaching the upper or lower limit of the dynamic range.

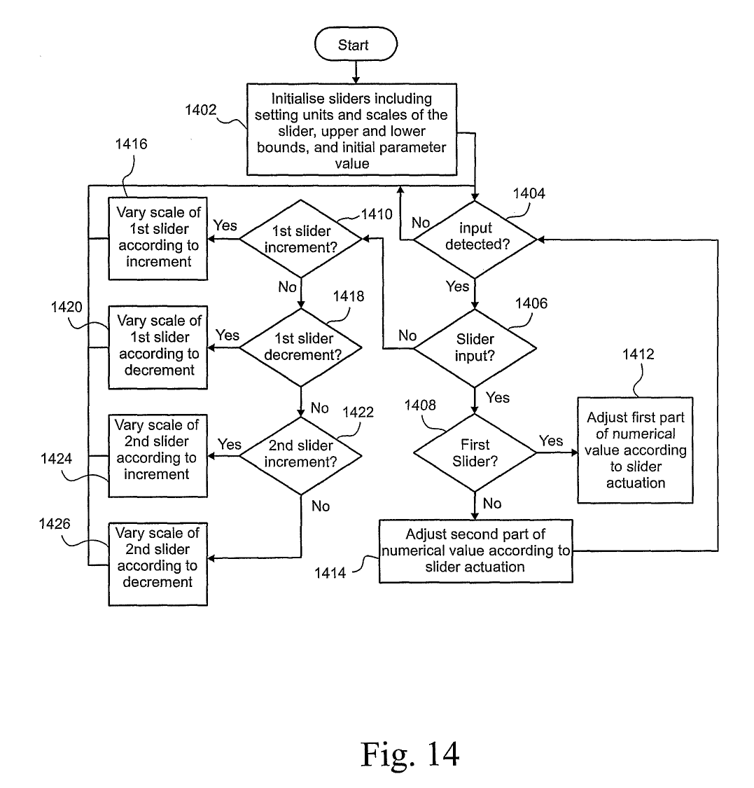

FIG. 14 depicts a flowchart 1400 showing the processing steps undertaken by an apparatus according to an embodiment of the present invention. The software can be used to implement a method according to the flowchart 1400.

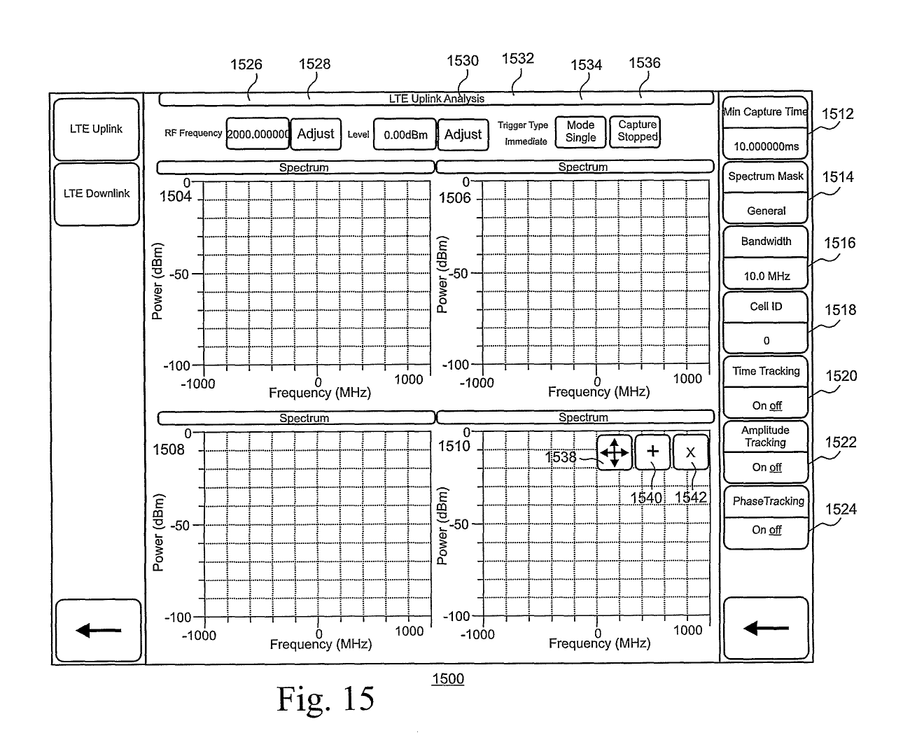

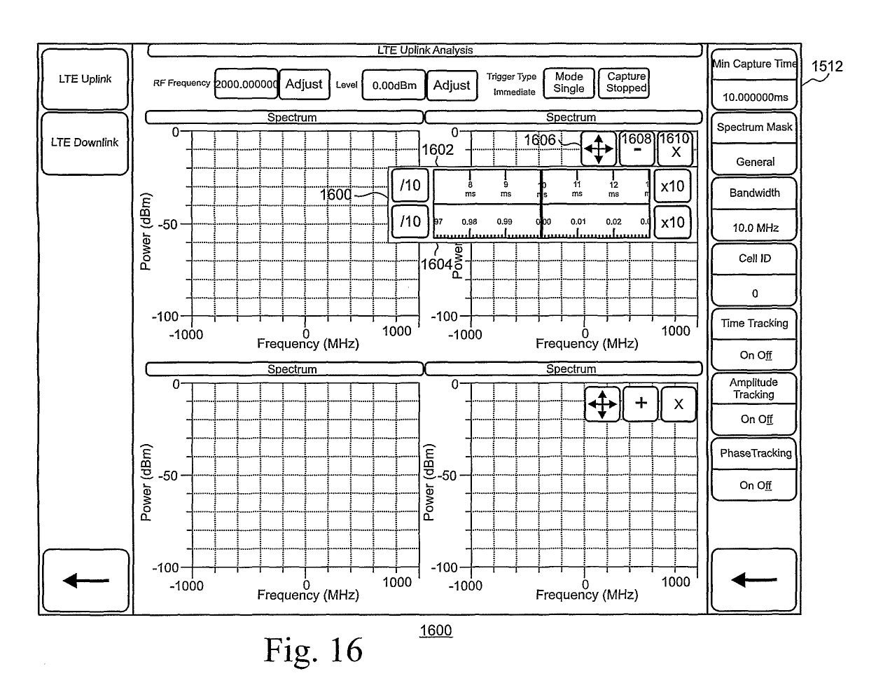

At step 1402, graphical depictions of the sliders are initialised and displayed. The initialisation process comprises accessing data governing the initial settings of the sliders such as, for example, the units and resolution of the scales, the upper and lower bounds of the scale and the initial parameter value. The sliders are realised as respective windows and are displayed when a numerical value is selected, which will be described in greater detail with reference to FIGS. 15 and 16.

The apparatus enters a loop in which repeated determinations are made regarding whether or not an input has been detected. Alternatively, embodiments can be realised that are interrupt driven such that actuating the touch-sensitive screen raises an interrupt that is serviced by steps 1404 onwards of the flowchart 1400.

A determination is made, at step 1404, regarding whether or not an input has been detected. If the determination is negative, control returns to step 1404. If the determination is positive control passes to step 1406.

Step 1406 determines if the input relates to a slider or an increment/decrement button. If the determination is that the input relates to a slider, processing continues at step 1408, otherwise the input is assumed to relate to an increment or decrement button of one of the sliders, whereupon processing moves to step 1410.

If it is established, at step 1406, that the input relates to a slider, an assessment is made, at step 1408, regarding whether or not the input relates to the first slider. If the assessment at step 1408 is positive, a first portion, such as, for example, the integer part, of the numerical value or parameter is adjusted according to the degree and direction of movement of the slider, that is, according to slider actuation, at step 1412.

If the assessment, at step 1408, is negative, it is assumed that the input relates to the second slider and processing continues at step 1414 where a second portion, such as, for example, the fractional or decimal part, of the numerical value or parameter is adjusted according to the degree and direction of slider actuation. Processing then resumes at step 1404.

Returning to step 1410, an assessment is undertaken to determine if the increment button associated with the first slider has been actuated. If that assessment is positive, the scale of the first slider is varied, that is, increased in a predetermined manner at step 1416 and processing then resumes at step 1404.

If the assessment at step 1410 is negative, a determination is made, at step 1418, regarding whether or not the input related to actuation of the first slider decrement button. If that determination is positive, the scale of the first slider is decreased in a predetermined manner at step 1420. Thereafter processing resumes at step 1404.

If the determination at step 1418 is negative, an assessment is made regarding whether or not the input is associated with the increment button of the second slider at step 1422. If the assessment at step 1422 is positive, the scale of the second slider is increased in a predetermined manner at step 1424 and processing thereafter resumes at step 1404.

If the assessment at step 1422 is negative, it is assumed that the input relates to the decrement button of the second slider and the scale of the second slider is varied accordingly at step 1426. Thereafter processing resumes at step 1404.

Referring to FIG. 15, there is shown a screen display 1500 of an apparatus (not shown) according to an embodiment of the invention. The display 1500 comprises a number of graphs 1504 to 1510 for depicting power spectra, that is, power, measured in dBm, against frequency. The screen display 1500 also shows a plurality of buttons 1512 to 1524 that are used to set respective parameters and/or invoke, apply or perform various filters, functions or actions. The first button 1512 sets the minimum capture time for establishing the power spectrum of an input signal (not shown). The second button 1514 is used to select the type of reference mask to be applied to the signal after establishing the signals power spectrum. The reference mask, in the embodiment illustrated, is labelled “General” and can be used to implement any type of mask that is desired to be associated with the label “General”. The third button 1516 is used to set and/or specify the system bandwidth of the input signal of interest, which is currently set to 10 MHz. The fourth button 1518 is used to display or select a cell ID, which corresponds to a cell whose RF characteristics, power spectrum in this case, are under investigation. The fifth button 1520 is used to enable or disable tracking time, which is an algorithm that can be used to improve analysis quality of the signal of interest. The sixth button 1522 is used to toggle amplitude tracking on and off, which is an algorithm that can be used to improve analysis quality of the signal of interest. The seventh button 1524 is used to toggle phase tracking on and off, which is an algorithm that can be used to improve analysis quality of the signal of interest.

The current centre frequency of the power spectrum to be determined is displayed in a corresponding field or window 1526 with an adjacent “Adjust” button 1528. Invoking the “Adjust” button 1528 displays a pair of sliders according to embodiments of the present invention that can be used to adjust the centre frequency of the power spectrum of interest. One slider adjusts the integer portion of the centre frequency while the other slider adjusts the decimal portion of the frequency. Similarly, a trigger power level is displayed in a corresponding field or window 1530 that also has a corresponding “Adjust” button 1532, which is used to adjust the power level at which the apparatus triggers. The triggering mode is displayed and selectable in a toggling manner by actuating a triggering button 1534. The sampling is started and stopped using a start/stop button 1536.

The display also shows three further buttons. The first of the three further buttons is a window movement button 1538, which, when actuated, is used to move a respective window in a drag and drop manner. The second button 1540 of the three is a used to minimise or maximise the window and the final button 1542 is used to close the window.

Referring to FIG. 16 there is shown the above screen display 1500 in which the “Min Capture Time” button 1512 has been actuated, which has resulted in a pair of sliders 1600 according to an embodiment of the present invention to be displayed. The pair of sliders 1600 comprise a first slider 1602 and a second slider 1604 that are respectively used to set the first and second portions such as, for example, integer and decimal parts, of the minimum period of time over which the power spectrum should be captured. It can be appreciated that the pair of sliders also comprises three additional buttons 1606 to 1610 that are used to position and size the window containing the pair of sliders 1600 in a manner substantially identical to that described above with respect to FIG. 15. The three additional buttons comprise a window position or movement button 1606 that can be used to change the position of the pair of sliders 1600 in a drag and drop manner. The second button 1608 of the three is a used to minimize or maximise the window and the final button 1610 is used to close the window.

The above embodiments have been described with reference to using a finger or stylus to control the movement of the slider and hence control the underlying numerical value or parameter represented by the slider. However, embodiments are not limited thereto. Embodiments can be realised in which some other input device is used to control the slider such as, for example, a mouse, which would be connected via the I/O subsystem 414.

Although the above embodiments have been described with reference to the units of measurement or physical entity being time and, more particularly, milliseconds, embodiments are not limited thereto. Embodiments can equally well be realised that use some other units of time or some other physical quantity such as, for example, units of frequency, units of voltage, units of current, modulation index, time such as Capture time or Capture length, measurement span, sample rate, graphical marker position in frequency or time. However, one skilled in the art appreciates that embodiments of the invention can be used to set or control any parameter.

The above embodiments have been described with reference to a digital signal generator. However, embodiments are not limited thereto. Embodiments can be realised using other apparatuses in which there is a desire to control a parameter. For example, embodiments can be used in relation to an oscilloscope, a spectrum analyser, Radio Test set, Radio test system or measurement system of any type, Vector signal Analysis, Vector Signal Generator and the like.

Embodiments have been described with reference to the numerical value or parameter representing or being associate with a corresponding physical characteristic of a signal. However, embodiments are not limited to such arrangements. Embodiments can be realised in which the numerical value or parameter controls a process. For example, if the parameter represents time, the sliders might be used to control the sampling period or frequency of an ND converter. Embodiments can be realised in the context of graphical scaling where the number entered affects a current scale of a graph. Furthermore, embodiments can be realised in the context of marker movement, where the number entered affects the location of a marker and, therefore, the displayed value of the marker.

The above embodiments have described with reference to the sliders using ticks. However, embodiments are not limited thereto. Embodiments can be realised in which some other indicia are used.

Although two sliders have been used in the above embodiments of the invention, embodiments can be realised in which some other number, that is, one or more, of sliders can be used in embodiments of the invention such as specifying coordinates in terms of X, Y and Z values simultaneously, or three levels of precision, such as a slider for the integer part of the value, a slider specifying up to 5 decimal places, and a slider specifying more than 5 decimal places. One skilled in the art appreciates that the flow chart shown in and described with reference to FIG. 14 can be suitably varied according to the number of graphical depictions, such as sliders, used to realise an embodiment

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing a system or method as claimed in any preceding claim and a machine readable storage storing such a program. Still further, such programs may be conveyed electronically via any medium such as a communication signal carried over a wired or wireless connection and embodiments suitably encompass the same.

1. An apparatus comprising:
a display; and
a display controller, the display controller being arranged to control displaying of at least one graphical depiction associated with a controlled parameter, the at least one graphical depiction comprising a first graphical depiction that is actuable to vary a first portion of the controlled parameter.

2. An apparatus as claimed in claim 1 wherein the at least one graphical depiction comprises a second graphical depiction that is actuable to vary a second portion of the controlled parameter.

3. An apparatus as claimed in claim 1 in which the first graphical depiction comprises a respective graduated moveable slider.

4. An apparatus as claimed in claim 1 in which the first graphical depiction comprises at least one actuable device for varying a scale of the first graphical depiction.

5. An apparatus as claimed in claim 2 in which the second graphical depiction comprises a respective graduated moveable slider.

6. An apparatus as claimed in claim 2 in which the second graphical depiction comprises at least one actuable device for varying a scale of the first graphical depiction.

7. (canceled)

8. A method for controlling a parameter, the method comprising actuating at least one of a plurality of graphical depictions representing respective portions of the parameter.

9. A method as claimed in claim 8 further comprising presenting a first graphical depiction of said plurality of graphical depictions as a moveable graduated slider.

10. A method as claimed in claim 8 further comprising actuating at least one actuable device for varying a scale associated with the first graphical depiction.

11. A method as claimed in claim 9 further comprising presenting a second graphical depiction of said plurality of graphical depictions as a moveable graduated slider.

12. A method as claimed in claim 11 comprising actuating at least one actuable device for varying a scale associated with the second graphical depiction.

13. A machine-readable storage storing a program comprising instructions that, when executed, implement a method as claimed in claim 8.

14-17. (canceled)
